(19) United States
(12) Patent Application Publication
(10) Pub. No.: US 2003/0053575 A1
(43) Pub. Date: Mar. 20, 2003

(54) Circuit arrangement for a receiver for receiving bursts and also a transceiver with a circuit arrangement of this kind

(75) Inventors: Marco Tomsu, Ditzingen (DE); Hardy Halbauer, Ettlingen (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/241,605

(22) Filed: Sep. 12, 2002

(30) Foreign Application Priority Data
Sep. 14, 2001 (EP) 01 440 303.4

(51) Int. Cl. H04L 25/38

(52) U.S. Cl. 375/369

(57) ABSTRACT

The invention relates to a circuit arrangement for a receiver for receiving bursts of a non-continuous signal, with a device for tuning to the current parameters of the signal required for evaluating a burst, in which the device for tuning is controlled in such a way that the parameters achieved at the end of a burst are extrapolated to the start of the next burst and used to evaluate it and as the starting point for further tuning, and also a transceiver for subscriber-side connection to a local wireless access network for the worldwide telecommunications network, the receiving part of which contains a circuit arrangement of this kind.

### BACKGROUND OF THE INVENTION

The invention is based on a priority application EP 01 440 303.4 which is hereby incorporated by reference.

The invention relates to a circuit arrangement for a receiver for receiving bursts of a non-continuous signal, and a transceiver for subscriber-side connection to a local wireless access network.

The invention has developed within the scope of tests on a broadband stationary radio access system operating in the range of 20 GHz and above. Such systems are usually constructed as cellular point-to-multipoint systems and use a network structure, comprising, for example, four sectors per base station. They are operated by adaptive multimode modulation. Each subscriber is allocated certain time slots within a frame sent by the base station, which he is to receive.

As the subscriber does not need to evaluate the time slots not intended for him and in fact is not allowed to, it is not guaranteed that he can receive them correctly at all. This leaves him with a non-continuous signal with individual bursts. It is therefore necessary for tuning to take place in each case to the current parameters of the signal required for evaluating a burst. Such parameters are, for example, the symbol rate and its phase or the frequency and phase of the carrier signal, as well as the signal amplitude. Basically this problem can be solved solely by digital signal processing; this however then presupposes multiple oversampling of the signal. Not only are the analog-to-digital converters required for this very expensive, they also limit the possible maximum operating frequency. It is also known to solve the problem by re-using the parameter values gained during the preceding burst for the current burst in each case. This is possible relatively without problems as long as, above all, the signal amplitude is involved. With other parameters this is not necessarily possible.

A comparable situation can also occur with broadband stationary radio access systems other than those mentioned.

The object of the invention is to cite a circuit arrangement and a transceiver equipped therewith, which can be constructed at a reasonable price and also enables safe tuning to the parameters of a burst even at very high frequencies.

### SUMMARY OF THE INVENTION

This object is achieved according to the invention by a circuit arrangement for a receiver for receiving bursts of a non-continuous signal, with a device for tuning to the current parameters of the signal required for evaluating a burst, the device for tuning being controlled in such a way that the parameters achieved at the end of a burst are extrapolated to the start of the next burst and used to evaluate it and as the starting point for further tuning. This object further is achieved by a transceiver for subscriber-side connection to a local wireless access network for the worldwide telecommunications network, the receiving part of the transceiver containing such circuit arrangement.

According to the invention, therefore, the parameters achieved at the end of a burst are used as the starting point for tuning, but the intervening period of time is therein taken into account by extrapolating these parameters to the start of the next burst and using them to evaluate it and as the new starting point for further tuning.

Extrapolation can be further improved if parameters gained from bursts further back are also involved.

The new parameters can soon be achieved by skilful procedure at the start of a new burst.

Further configurations of the invention are to be found in the following description.

### BRIEF DESCRIPTION OF THE DRAWINGS

The invention is explained further with the aid of the attached drawings.

FIG. 1 shows a broadband stationary radio access system, in which circuit arrangements according to the invention are used in transceivers according to the invention.

FIG. 2 shows the frame structure of a signal, which is transmitted by a radio base station and contains bursts which are to be evaluated by circuit arrangements according to the invention in transceivers according to the invention.

FIG. 3 shows an embodiment example with a circuit arrangement according to the invention.

FIG. 4 shows the course of tuning to the current parameters.

### DETAILED DESCRIPTION

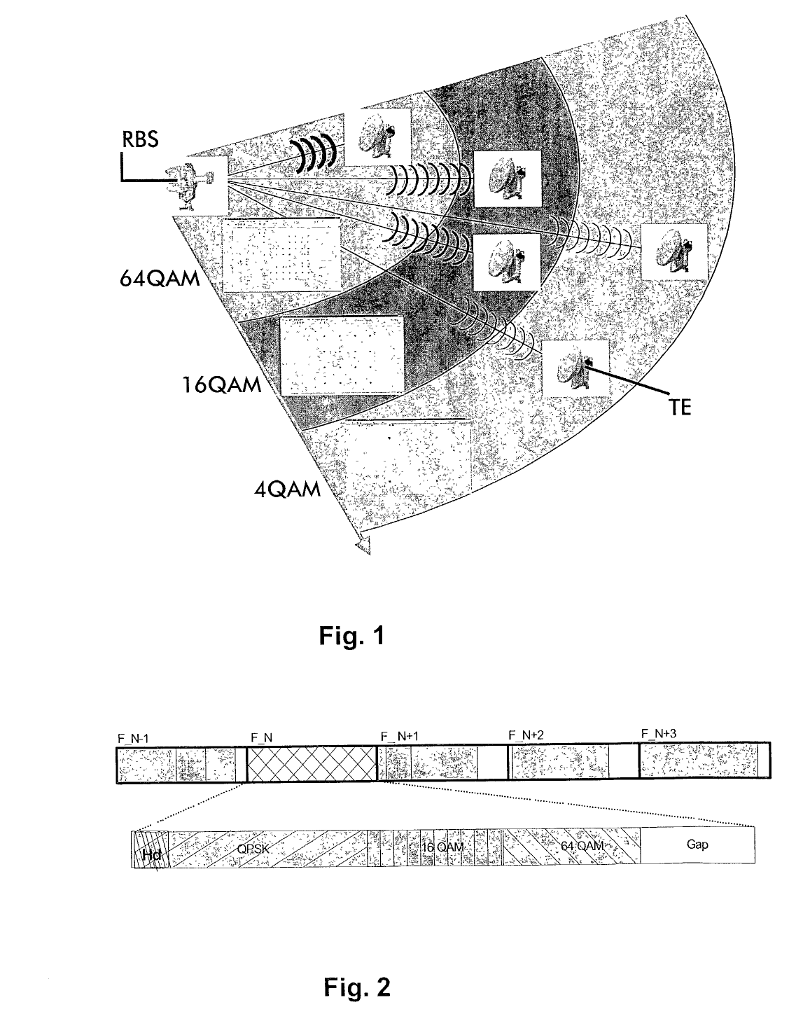

With the aid of FIG. 1 the structure of a broadband stationary radio access system operated by adaptive multimode modulation is first described.

FIG. 1 shows a radio base station RBS, located in the centre of a radio cell, only one sector of which is shown here at approximately 90 degrees. This radio cell, and therefore also the illustrated sector, is divided into three zones, here designated as 64QAM, 16QAM and 4QAM. These designations indicate the type of modulation provided for the respective zones. This modulation type is also illustrated in each case by a latched-in diagram. Five subscriber devices TE are also drawn in. From the radio base station RBS to each of the subscriber devices TE a connection line is drawn in, carrying symbols for radio waves running towards the subscriber devices TE. The strength of these symbols indicates the signal field strength occurring in the respective subscriber device TE and the capacity of the modulation process used.

Radio access systems of the type shown are currently standardised in the standardising committees of ETSI BRAN and IEEE 802.16. By contrast with the current mobile radio system GSM, for example, here transmission is intended to take place with the same power to nearby stations as to more distant ones. The consequent higher signal level at the respective receiving point is used to compact communications traffic by a different choice of modulation and in this way to achieve a higher throughput per time unit. Therefore in the inner zone a 64-stage quadrature amplitude modulation 64QAM is used, in the central zone a 16-stage quadrature amplitude modulation 16QAM and in the outer zone a 4-stage quadrature amplitude modulation 4QAM. By means of this compaction the capacity can be increased by approximately the factor two to three in the entire system. The zones are naturally in practice not circular, as suggested here. Local conditions are more likely to result in field strength distribution which does not depend solely on the distance from the base station. Disturbances by reflections and multi-path reception and interferences by other stations also have to be taken into account. However, this ultimately happens automatically.

The 4-stage quadrature amplitude modulation 4QAM is largely identical in properties to modulation type QPSK (Quaternary Phase Shift Keying), in which the same statuses are achieved not by changes in amplitude, but by phase transitions. Insofar as differences exist at all, they at least do not hinder the cooperation between a 4QAM sender and a QPSK receiver or vice versa.

As already in the above-mentioned mobile radio system, here too all connected subscriber devices TE are operated from the base station RBS in time multiplex. In this way, as already mentioned initially, at least in the outer zones the signal does not have to be constantly received for the subscriber devices TE in such a way that it can be evaluated. To this is added the fact that with less traffic not all the time slots are occupied. Continuous reception and continuous tuning to the various parameters of the received signal are therefore not possible. This is of particular significance with the higher value modulation types occurring here. (A receiver capable of evaluating higher value signals of this kind is of course ideally suited if only simpler signals, possibly continuous ones, are to be received.)

In the system according to FIG. 1 only the direction from the network (base station RBS) to the subscriber (subscriber device TE), the so-called downwards direction, otherwise “downlink”, is drawn in. In the system, regarded here as the starting point of the embodiment example, there is naturally also an opposite direction, the so-called upwards direction, otherwise “uplink”. The present invention, though, at least in this system, relates only to the configuration of the receiving part of the subscriber device TE. Its sending part is only also involved insofar as it normally forms an entity with the receiving part. Basically, though, it is not ruled out that in simply positioned cases the receiving part of the base station is also configured according to the invention.

The signal structure on the “downlink” is now briefly described with the aid of FIG. 2. Transmission by the base station RBS is based on a continuous synchronous timeframe signal. Shown are timeframes F_N−1, F_N, F_N+1, F_N+2 and F_N+3. Timeframe F_N is illustrated in more detail. It has four larger segments, a first one with modulation type QPSK, a second with modulation type 16QAM, a third with modulation type 64QAM and a transmission pause designated as Gap. The first segment with modulation type QPSK begins with a head part Hd, the so-called header. The rest of the first segment and the two following segments are subdivided into time slots, not illustrated here, allocated to the individual subscriber devices TE.

The header Hd, among other things, serves to allocate these time slots, in a way which does not need to be further examined here. The header Hd must in any case be received and evaluated by all the subscriber devices TE. However, this header Hd is usually preceded by a period of time, at least the transmission pause Gap of the preceding timeframe, in which no signal can be received and evaluated. The receivable signal is therefore, as the person skilled in the art says, “like a burst”. Since these are ultimately signals with digital content, signal segments of this kind are designated, if the expression “burst” is not used, as bursts.

For receiving a burst of this kind the header Hd therefore first contains a preamble, which serves to identify the start of the frame and for tuning. Receiving a single preamble of this kind is, however, not generally sufficient to be able to receive everything immediately on switching on. In some cases the preambles of several frames have to be evaluated before all the parameters have been finely tuned and the signal contents can be correctly evaluated. Tuning and fine-tuning are helped by the fact that not only the preamble itself can be used for this, but in fact at least the entire first segment modulated in QPSK can be involved in this. In some cases the second and third segments can also be involved in subsequent fine-tuning. The parameters achieved may not therein be supplied during the non-evaluatable time segments. As soon as the header Hd can be evaluated, time slots can be allocated, whose content can then be evaluated.

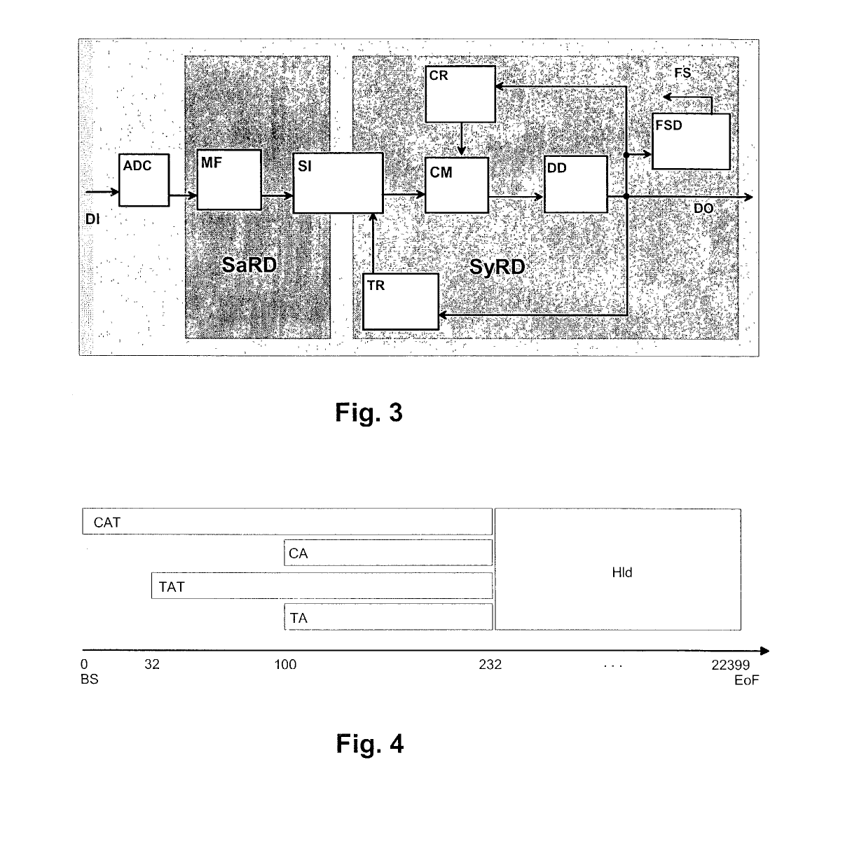

With the aid of FIG. 3 an embodiment example with a circuit arrangement according to the invention is now described. FIG. 3 shows this embodiment example in the form of a block diagram.

The figure shows an analog-to-digital converter ADC, following a data input DI, a domain SaRD (Sample Rate Domain), where operation is at the sample rate and a domain SyRD (Symbol Rate Domain), where operation is at the symbol rate. The data output DO is illustrated at the output.

Domain SaRD has a matched filter MF and, with a device for symbol interpolation SI, extends into domain SyRD. This further has a complex mixer CM, a decision device DD, a device for detecting symbol rate, or timing, TR, a device for detecting carrier frequency and phase CR and a frame start detector FSD. The frame start detector FSD emits a frame start signal FS.

Preceding the data input DI is a normal HF input part, which supplies the I and Q portions (in-phase and quadrature portions) of the received signal separately in an intermediate frequency position. To be precise what we have here is a not yet finely tuned zero intermediate frequency and therefore in fact a basic band position. The arrows leading from here to the data output DO are therefore always to be seen as double. Both portions are separately digitalized in the analog-to-digital converter ADC, which therefore consists of two identical parts. The sample rate for this can be relatively low with the configuration according to the invention of the following circuit arrangement. Only a very small oversampling is necessary, possibly with the factor 2 . . . 4. The control voltage for the automatic gain control AGC, not drawn in here, is also gained from the output values of the analog-to-digital converter ADC.

Then in the matched filter MF the signals (in-phase and quadrature signals) are subjected to filtering. This is done in a way known per se taking into account the current oversampling rate, which, as mentioned, needs to be only relatively small here. The output values of this filter are involved, again in a way known per se, in rough tuning to the carrier frequency.

In the device for symbol interpolation SI the amplitudes located in the centre of the respective eye aperture of the signal are detected at the more or less exact symbol rate from the device for detecting symbol rate TR from the support sites resulting from the (minimally) oversampled signal. From here onwards, in domain SyRD the circuit arrangement operates further only at the symbol rate.

The device for symbol interpolation SI is followed by a device for balancing errors between the two channels with the I and Q portions and a device for equalising channels, neither of which is shown.

In the adjoining complex mixer CM these two portions are mixed down into the basic band. In the example another frequency inaccuracy of 250 kHz is balanced in both directions.

The decision device DD restores the original symbol sequence and outputs it at the data output DO.

This output data sequence is now used for various purposes, wherein the sequence of the values at the output of the complex mixer CM can also be involved.

The most important thing is first the detection of the frame start(s) by means of the frame start signal FS in the frame start detector FSD, which is done in a way known per se by forming a correlation signal. With known burst receivers detection of the frame start already takes place, however, in domain SaRD where operation is at the sample rate. This requires that the signal with which correlation has to take place is also not a simple binary signal. Correlation is therefore brought back to a convolution, at which a large number of multiplications has to be carried out with very great precision. By forming the frame start signal first in domain SyRD the large number of multiplications can be brought back to a few simple binary comparisons. The outlay is therein drastically reduced.

This is described in greater detail with the aid of FIG. 4. This shows the chronological course of the tuning process inside a frame and therefore inside a burst. Shown is a complete frame with 22400 multi-stage symbols. It begins with the frame start BS (burst start), which is simultaneously the start of a burst and also the start of a header Hd with the preamble. Tuning takes place in four phases which run into one another. These are the phases of carrier acquisition and tracking CAT, timing acquisition and tracking TAT, carrier averaging CA and timing averaging TA. Then there follows a phase H1d, during which tuning can take place only conditionally. On a timing axis the symbol number 0, then the position of symbol 32, which marks the end of the preamble, the position of symbol 100 as important point in the tuning process used as an example, the position of symbol 232 as the end of the header Hd and the end of the frame EoF are further drawn in at the frame start BS.

Finally, the control variables of two control circuits always have to be detected here. One control circuit relates to carrier frequency and carrier phase and the other control circuit relates to the symbol rate. Normally gaining the first parameters takes place in such a way that at first the symbol rate and the carrier frequency and carrier phase still take place by correlation in the domain of the sample rate, similarly to the identification of the frame start.

Here, however, this procedure is preferably deviated from as follows. Starting from an output value for carrier frequency and carrier phase, first during the first 32 symbols, in other words at the end of the preamble, an attempt is made only to improve this value. On switching on, this output value of course corresponds to the frequency and phase error zero. Later this output value is a value achieved at the end of the preceding burst. Then, also starting from an output value, an attempt is made to improve the symbol rate; detecting and improving the value for carrier frequency and carrier phase continue unchanged. Extrapolation of these two parameters with a view to an output value for tuning in the next burst begins already with the 100^{th} symbol. As long as tuning has not progressed so far that the received signal can already be safely demodulated, at the end of the header Hd, in other words at symbol 232, tuning is stopped and further tuning does not take place until the next frame start. The end of the header Hd here marks the domain in which it is still safe to transmit in the lowest modulation stage, namely in QPSK or 4QAM.

Extrapolation takes place in the simplest case by means of updating the achieved value, wherein in some cases the chronological progress of the phases should be taken into account. An improvement results by simple average value formation with one or more preceding parameter values or by other extrapolations taking into account a plurality of preceding values.

As soon as tuning has progressed far enough for the header to be fully demodulated, there is a switchover from acquiring the parameters to tracking them. This is done on the one hand in that in the control circuits the filters are switched to narrower bands and on the other hand in that the signal portions following the header are also involved, whereby tuning to the higher value types of modulation also then takes place. This means that it is also possible to establish and communicate to the base station what type of modulation can still safely be used based on the existing signal field strength and the interferences.

The course described here with the aid of FIG. 4 is controlled in domain SyRD in a device, not explicitly illustrated in FIG. 3, which controls the described course in the form of a course control unit.

Patent claims

1. A circuit arrangement for a receiver for receiving bursts of a non-continuous signal, with a device for tuning to the current parameters of the signal required for evaluating a burst, the device for tuning being controlled in such a way that the parameters achieved at the end of a burst are extrapolated to the start of the next burst and used to evaluate it and as the starting point for further tuning.

2. A transceiver for subscriber-side connection to a local wireless access network for the worldwide telecommunications network, the receiving part of the transceiver containing a circuit arrangement according to claim 1.

3. The circuit arrangement according to claim 1, the device for tuning being further controlled in such a way that parameters gained from bursts further back are also involved in the extrapolation.

4. The circuit arrangement according to claim 1, the device for tuning being further controlled in such a way that at the start of a new burst there is first further tuning to the parameters responsible for detection of the carrier phase and, only with a delay further tuning to the parameters responsible for detection of the symbol rate.
